(19) United States
(12) Patent Application Publication
(10) Pub. No.: US 2024/0262985 A1
(43) Pub. Date: Aug. 8, 2024

(54) VIBRATION-DAMPING RUBBER COMPOSITION AND VIBRATION-DAMPING RUBBER MEMBER

(71) Applicant: Sumitomo Riko Company Limited, Aichi (JP)

(72) Inventors: Yuto Watanabe, Aichi (JP); Seiji Kasai, Aichi (JP); Toyohisa Tohyama, Aichi (JP)

(73) Assignee: Sumitomo Riko Company Limited, Aichi (JP)

(21) Appl. No.: 18/628,842

(22) Filed: Apr. 8, 2024

Related U.S. Application Data
(63) Continuation of application No. PCT/JP2022/047885, filed on Dec. 26, 2022.

(30) Foreign Application Priority Data
Dec. 27, 2021 (JP) 2021-212744

(51) Int. Cl. C08K 5/548; C08K 3/04; C08K 3/36; C08K 9/06; F16F 1/36

(52) U.S. Cl. CPC C08K 5/548; C08K 3/04; C08K 3/36; C08K 9/06; F16F 1/3605; C08K 2201/005; C08K 2201/006; F16F 2224/025

(57) ABSTRACT

Provided are a vibration-damping rubber composition and a vibration-damping rubber member which have excellent durability, can attain a reduction in dynamic-to-static modulus ratio, and can exhibit excellent scorch resistance even in wet-heat environments, etc. This vibration-damping rubber composition comprises a diene-based rubber composition comprising the following (A) to (C). (A) A diene-based rubber. (B) Silica having a silanol group density of four groups per nm² or greater, a BET specific surface area of 13-60 m²/g, and an average particle diameter of 3-10 μm. (C) A silane coupling agent having a sulfide group and a mercapto group in the molecule.

### CROSS-REFERENCE TO RELATED APPLICATION

This application is a continuation application of International Application number PCT/JP2022/047885 on Dec. 26, 2022, which claims the priority benefit of Japan Patent Application No. 2021-212744, filed on Dec. 27, 2021. The entirety of each of the above-mentioned patent applications is hereby incorporated by reference herein and made a part of this specification.

### TECHNICAL FIELD

The present disclosure relates to a vibration-damping rubber composition and a vibration-damping rubber member used for vibration-damping applications in vehicles such as automobiles and trains.

### BACKGROUND ART

In the technical field of vibration-damping rubber, it is required to have high durability and a low dynamic-to-static modulus ratio (a decreased value of dynamic-to-static modulus ratio [dynamic spring constant (Kd)/static spring constant (Ks)]). In order to satisfy these requirements, a formulation system in which a diene-based rubber, which is a polymer of a vibration-damping rubber composition, contains a filler such as carbon black and a silica, and additionally, a silane coupling agent is used in combination to improve dispersion of the silica has been established (for example, refer to Patent Literature 1 to 4).

In addition, in order to further lower the dynamic-to-static modulus ratio, in addition to highly dispersed silica, the crosslinked structure of the polymer rubber and bonding between the silica and the polymer rubber using a silane coupling agent are important.

### CITATION LIST

### Patent Literature

[Patent Literature 1]
Japanese Patent No. 3838154
[Patent Literature 2]
Japanese Patent Laid-Open No. 2017-8161
[Patent Literature 3]
WO 2016/204012
[Patent Literature 4]
Japanese Patent Laid-Open No. 2006-199899

Here, for example, in the vibration-damping rubber composition described in Patent Literature 4, a silica having a large primary particle diameter is used, and a lower dynamic-to-static modulus ratio can be achieved compared to when a general silica is used.

However, when the silica having a large primary particle diameter is used, since the interaction between the silica and the rubber becomes weak, there is a disadvantage of durability of the vibration-damping rubber deteriorating.

In addition, as described above, in a conventional vibration-damping rubber composition containing a silica and a silane coupling agent, compared to when carbon black is used as a silica (filling material), the rubber composition tends to scorch (rubber burn), which causes problems during long-term storage.

In addition, as described above, in the vibration-damping rubber composition containing a silica and a silane coupling agent, in order to further improve durability and the like, for example, methods such as using a sulfide-based or mercapto-based silane coupling agent have been considered, but when these methods are applied, as described above, there is a problem that scorching of the rubber composition proceeds more easily (the scorch time becomes shorter).

The present disclosure has been made in view of the above circumstances, and provides a vibration-damping rubber composition and a vibration-damping rubber member, which can achieve excellent durability and a low dynamic-to-static modulus ratio, and can exhibit excellent scorch resistance.

The inventors conducted extensive studies in order to solve the above problems. In the process of studies, in order to make it possible to achieve the same low dynamic-to-static modulus ratio as the large-particle-size silica without using the large-particle-size silica and without deteriorating the durability of the vibration-damping rubber like when using the large-particle-size silica, the inventors thought to use a silica having a density of silanol groups, which are bonding groups with a silane coupling agent and reactive groups with a diene-based rubber, of 4 groups/nm² or greater, a BET specific surface area of 13 to 60 m²/g, and an average particle diameter of 3 to 10 μm as the silica to be added to the rubber composition. Also, the inventors conducted extensive studies, in combination with the specific silica, regarding a silane coupling agent that can improve durability of the vibration-damping rubber without impairing the effects of the silica, and can exhibit an excellent scorch resistance effect. As a result, they found that, when a silane coupling agent having both a sulfide group and a mercapto group in the molecule is used, its molecular structure is a structure in which a side chain (sulfide group) acts to cover a mercapto group, and thus rapid vulcanization is inhibited, and for example, the problem of scorch proceeding easily, which occurs when only a mercapto-based silane coupling agent is used, can be solved.

### SUMMARY

That is, the gist of the present disclosure includes the following [1] to [7].
[1] A vibration-damping rubber composition comprising a diene-based rubber composition containing the following (A) to (C):
(A) a diene-based rubber;
(B) a silica having a silanol group density of 4 groups/nm² or greater, a BET specific surface area of 13 to 60 m²/g, and an average particle diameter of 3 to 10 μm; and
(C) a silane coupling agent having a sulfide group and a mercapto group in the molecule.
[2] The vibration-damping rubber composition according to [1],
   wherein the content of the above (C) with respect to 100 parts by mass of the above (A) is 0.5 to 10 parts by mass.
[3] The vibration-damping rubber composition according to [1] or [2],
   wherein the content of the above (B) with respect to 100 parts by mass of the above (A) is 10 to 100 parts by mass.
[4] The vibration-damping rubber composition according to any one of [1] to [3], further including the following (D):
(D) carbon black.
[5] The vibration-damping rubber composition according to [4],
   wherein the content of the above (D) with respect to 100 parts by mass of the above (A) is 0.1 to 5 parts by mass.
[6] The vibration-damping rubber composition according to [4] or [5],
   wherein the BET specific surface area of the above (D) is 10 to 150 m²/g.
[7] A vibration-damping rubber member comprising a vulcanized component of the vibration-damping rubber composition according to any one of [1] to [6].

### DESCRIPTION OF EMBODIMENTS

### Advantageous Effects of Disclosure

As described above, the vibration-damping rubber composition of the present disclosure contains a polymer composed of a diene-based rubber (A), a silica (B) having a silanol group density, a BET specific surface area, and an average particle diameter within specific ranges, and a silane coupling agent (C) having a sulfide group and a mercapto group in the molecule. Therefore, it is possible to achieve high durability and a low dynamic-to-static modulus ratio and exhibit excellent scorch resistance.

Next, embodiments of the present disclosure will be described in detail. However, the present disclosure is not limited to the embodiments.

Here, in the present disclosure, unless otherwise noted, the expression “X to Y” (X and Y are arbitrary numbers) means “X or more and Y or less,” and also means “preferably more than X” or “preferably less than Y.”

In addition, the expression “X or more” (X is an arbitrary number) or “Y or less” (Y is an arbitrary number) also means “preferably more than X” or “preferably less than Y.”

As described above, the vibration-damping rubber composition that is one embodiment of the present disclosure (hereinafter referred to as “the present vibration-damping rubber composition”) is a diene-based rubber composition containing the following (A) to (C).
(A) a diene-based rubber.
(B) a silica having a silanol group density of 4 groups/nm² or greater, a BET specific surface area of 13 to 60 m²/g, and an average particle diameter of 3 to 10 μm.
(C) a silane coupling agent having a sulfide group and a mercapto group in the molecule.

As described above, since the present vibration-damping rubber composition is a diene-based rubber composition, the diene-based rubber (A) is used as the polymer. Here, since it is a diene-based rubber composition as described above, it is preferable not to use a polymer other than the diene-based rubber (A) in the present vibration-damping rubber composition, but a small amount (less than 30 mass % of the entire polymer) of a polymer other than the diene-based rubber (A) can be used.

Hereinafter, materials constituting the present vibration-damping rubber composition will be described in detail.

### [Diene-Based Rubber (A)]

As the diene-based rubber (A) used in the present vibration-damping rubber composition, preferably, a diene-based rubber containing a natural rubber (NR) as a main component is used. Here, the “main component” refers to a case in which 50 mass % or more of the diene-based rubber (A) is natural rubber, preferably 80 mass % or more of the diene-based rubber (A) is natural rubber, and more preferably 90 mass % or more of the diene-based rubber (A) is natural rubber, and includes a case in which the diene-based rubber (A) is composed of only natural rubber. In this manner, when the natural rubber is the main component, it becomes excellent in terms of strength and a low dynamic-to-static modulus ratio.

In addition, examples of diene-based rubber other than natural rubber include butadiene rubber (BR), styrene-butadiene rubber (SBR), chloroprene rubber (CR), isoprene rubber (IR), acrylonitrile-butadiene rubber (NBR), ethylene-propylene-diene rubber (EPDM), butyl rubber (IIR), and chloroprene rubber (CR). These may be used alone or two or more thereof may be used in combination. Here, these diene-based rubbers are preferably used in combination with natural rubber.

### [Silica (B)]

In addition, in order to achieve high durability, a low dynamic-to-static modulus ratio, and the like, as the silica (B) used in the present vibration-damping rubber composition, as described above, a silica having a silanol group density of 4 groups/nm² or greater, a BET specific surface area of 13 to 60 m²/g, and an average particle diameter of 3 to 10 μm is used.

Here, the average particle diameter is an average particle diameter measured by a Coulter method.

In addition, the silanol group density of the silica (B) is a silanol group density on the silica surface calculated by a Sears titration method.

Here, specifically, the silanol group density of the silica (B) is calculated from the Sears titration amount measured by the method described in Analytical Chemistry, vol. 28, No. 12, 1956, 1982 to 1983, G. W. Sears. Here, when the silanol group density is calculated, the relationship between the Sears titration amount and the amount of silanol groups is based on the following ion-exchange reaction.

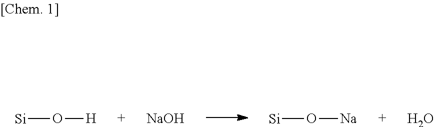

Here, examples of methods of calculating the silanol group density include an ignition loss (TG) measurement method in addition to the above Sears titration method. When the silanol group density is calculated by the ignition loss (TG) measurement method, since all the loss on heating is counted as —OH, —OH in fine parts of silica aggregate and inside primary particles, which are unrelated to interaction with rubber, is also counted. On the other hand, the measurement of the silanol group density by the above Sears titration method is a method of counting only —OH on the surface of silica aggregates. Therefore, in consideration of the dispersion state of silica in the rubber and the bonding state with the rubber, the silanol group density calculated by the Sears titration method is preferable because the measurement method exhibits a state closer to the actual state.

In addition, in order to achieve high durability, a low dynamic-to-static modulus ratio, and the like, the BET specific surface area of the silica (B) is preferably in a range of 15 to 60 m²/g, and more preferably in a range of 15 to 35 m²/g.

Here, when the BET specific surface area is too small, the primary particle diameter becomes too large, and the contact area with the diene-based rubber (A) itself becomes small, and thus sufficient reinforcing properties cannot be obtained, and the tensile strength at break (TS) and the elongation at break (EB) tend to deteriorate, and on the other hand, when the BET specific surface area is too large, the primary particle diameter becomes too small, aggregation between primary particles becomes strong, and thus dispersion becomes poor, and dynamic properties tend to deteriorate.

Here, for example, the BET specific surface area of the silica (B) can be measured by a BET specific surface area measurement device (4232-II, commercially available from Micro Data Co., Ltd.) after degassing a sample at 200° C. for 15 minutes and using a mixed gas (N₂: 70%, He: 30%) as an adsorption gas.

Methods of preparing the silica (B) that satisfies the above requirements include a precipitated silica reaction method, and for example, it can be prepared according to a method of neutralizing an alkali silicate aqueous solution (commercially available sodium silicate aqueous solution) in a mineral acid to precipitate precipitation silica. Specifically, first, a method in which a sodium silicate aqueous solution with a predetermined concentration is poured into a predetermined amount reaction container, and a mineral acid is added under predetermined conditions (one-side addition reaction) or sodium silicate and a mineral acid are added to a reaction solution containing a certain amount of hot water in advance for a certain time while controlling the pH and temperature (simultaneous addition method) can be used. Next, the precipitated silica slurry obtained by the above method is filtered and washed using a filtration machine (for example, a filter press, a belt filter, etc.) that can wash cake to remove by-product electrolytes. Then, the obtained silica cake is dried by a dryer. Generally, this silica cake is made into a slurry and dried using a spray dryer, but the cake may be left without change and dried in a heating oven or the like. The dried silica obtained in this manner is then pulverized to have a predetermined average particle diameter using a pulverizer, and as necessary, coarse particles are additionally cut out using a classifier to prepare silica. This pulverization and classification operation is performed to adjust the average particle diameter and cut out coarse particles, and the pulverization method (for example, an airflow type pulverizer, an impact type pulverizer, etc.) is not particularly limited. In addition, similarly, in the classifier, the classification method (for example, a wind type, a sieve type, etc.) is not particularly limited.

The content of the silica (B) obtained in this manner with respect to 100 parts by mass of the diene-based rubber (A) is preferably 10 to 100 parts by mass in order to achieve high durability, a low dynamic-to-static modulus ratio, and the like, and more preferably 10 to 80 parts by mass in the same viewpoint.

### [Silane Coupling Agent (C)]

In addition, as described above, as the silane coupling agent (C) used in the present vibration-damping rubber composition, a silane coupling agent having a sulfide group and a mercapto group in the molecule is used. Examples of such silane coupling agents include a silane coupling agent represented by the following General Formula (1).

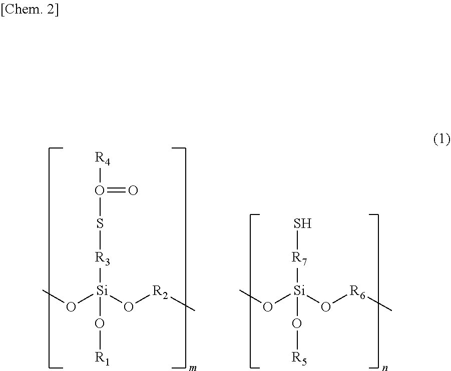

{in Formula (1), R₁ and R₅ are a linear hydrocarbon group having a hydroxyl group, R₂ and R₆ are a linear hydrocarbon group, R₃ and R₇ are a hydrocarbon group, R₄ is a hydrocarbon group, m is an integer of 1 to 100,000, and n is an integer of 1 to 100,000.}

In General Formula (1), R₁ and R₅ are preferably functional groups having a hydroxyl group at the end of a linear hydrocarbon group having 1 to 10 carbon atoms, and more preferably functional groups having a hydroxyl group at the end of a linear hydrocarbon group having 2 to 4 carbon atoms. Here, R₁ and R₅ may be the same as or may be different from each other.

R₂ and R₆ are preferably a linear hydrocarbon chain having 1 to 10 carbon atoms and more preferably a linear hydrocarbon chain having 2 to 4 carbon atoms. Here, R₂ and R₆ may be the same as or may be different from each other.

R₃ and R₇ are hydrocarbon chains and may be linear or branched. R₃ and R₇ are preferably a linear hydrocarbon chain having 1 to 10 carbon atoms, and more preferably a linear hydrocarbon chain having 2 to 4 carbon atoms. Here, R₃ and R₇ may be the same as or may be different from each other.

R₄ is a hydrocarbon group, and may be linear or branched. R₄ is preferably a linear hydrocarbon group having 1 to 18 carbon atoms, and more preferably a linear hydrocarbon group having 6 to 12 carbon atoms.

When the range is specified as described above, the problems of the present disclosure can be solved additionally. Here, R₁ to R₇ can be confirmed by 1H-NMR.

In addition, the silane coupling agent (C) shown in General Formula (1) is a copolymer of m structural units (monomers) and n structural units (monomers) shown in General Formula (1), and can be obtained by random copolymerization, alternating copolymerization, block copolymerization, or graft copolymerization.

Here, in General Formula (1), preferably, m is an integer of 2 to 1,000, and n is an integer of 2 to 1,000.

The ratio of m and n shown in General Formula (1) is preferably m:n=10:90 to 90:10, more preferably m:n=20:80 to 80:20, and still more preferably m:n=40:60 to 60:40.

When the range is specified as described above, the problems of the present disclosure can be solved additionally. Here, m and n are measured by gel permeation chromatography (GPC). In addition, men is measured by 1H-NMR.

As the silane coupling agent (C), a solid silane coupling agent can be used, but in consideration of dispersion in the rubber composition, handling properties and the like, a liquid silane coupling agent is preferable.

Here, when the silane coupling agent (C) is a “liquid” silane coupling agent, it means that it is a silane coupling agent that exhibits a viscosity of 6,000 Pads or less at room temperature (23° C.). The viscosity can be measured using, for example, a B-type viscometer.

The content of the silane coupling agent (C) obtained in this manner with respect to 100 parts by mass of the diene-based rubber (A) is preferably 0.5 to 10 parts by mass in order to achieve high durability, a low dynamic-to-static modulus ratio, and the like, and more preferably 1 to 8 parts by mass in the same viewpoint.

Here, the present vibration-damping rubber composition may further contain one or more silane coupling agents other than the silane coupling agent (C). In order to prevent the effects of the present disclosure from being impaired, the content of other silane coupling agents with respect to a total amount of the silane coupling agent (C) and other silane coupling agents is preferably 20 mass % or less and more preferably 10 mass % or less.

It is particularly preferable that the present vibration-damping rubber composition do not contain any other silane coupling agent (a content of 0 mass %).

In the present vibration-damping rubber composition, in addition to the essential components (A) to (C), carbon black, a vulcanizing agent, a vulcanization accelerator, a vulcanization aid, an antioxidant, a process oil, a wax and the like may be appropriately added as necessary.

The present vibration-damping rubber composition may contain, as necessary, a small amount of carbon black, as long as it does not affect a low dynamic-to-static modulus ratio achieved by the silica (B) and the silane coupling agent (C). It is preferable to contain a small amount of carbon black in this manner for fatigue resistance.

As the carbon black, one having a BET specific surface area of 10 to 150 m²/g is preferably used, and one having a BET specific surface area of 65 to 85 m²/g is more preferably used.

Here, for example, the BET specific surface area of the carbon black can be measured by a BET specific surface area measurement device (4232-II, commercially available from Micro Data Co., Ltd.) after degassing a sample at 200° C. for 15 minutes and using a mixed gas (N₂: 70%, He: 30%) as an adsorption gas.

Regarding the grade of carbon black, in consideration of reinforcing properties, durability and the like, various grades of carbon black such as FEF grade, MAF grade, GPF grade, SRF grade, FT grade, and MT grade are used. These may be used alone or two or more thereof may be used in combination. Among these, FEF grade carbon black is preferably used in consideration of the above viewpoint.

When the carbon black is used, the content thereof with respect to 100 parts by mass of the diene-based rubber (A) is preferably in a range of 0.1 to 10 parts by mass and particularly preferably in a range of 3 to 7 parts by mass in order to improve the fatigue resistance.

Examples of vulcanizing agents include sulfur (powdered sulfur, precipitated sulfur, and insoluble sulfur). These may be used alone or two or more thereof may be used in combination.

The amount of the vulcanizing agent added with respect to 100 parts by mass of the diene-based rubber (A) is preferably in a range of 0.3 to 7 parts by mass and particularly preferably in a range of 1 to 5 parts by mass. That is, when the amount of the vulcanizing agent added is too small, a sufficient crosslinked structure cannot be obtained, the dynamic-to-static modulus ratio and the settling resistance tend to deteriorate, and on the other hand, when the amount of the vulcanizing agent added is too large, the heat resistance tends to decrease.

Examples of vulcanization accelerators include thiazole-based, sulfenamide-based, thiuram-based, aldehyde ammonia-based, aldehyde amine-based, guanidine-based, and thiourea-based vulcanization accelerators. These may be used alone or two or more thereof may be used in combination. Among these, sulfenamide-based vulcanization accelerators are preferable because they have excellent crosslinking reactivity.

In addition, when the vulcanization accelerator is used, the amount thereof added with respect to 100 parts by mass of the diene-based rubber (A) is preferably in a range of 0.5 to 7 parts by mass and particularly preferably in a range of 0.5 to 5 parts by mass.

Examples of thiazole-based vulcanization accelerators include dibenzothiazyl disulfide (MBTS), 2-mercaptobenzothiazole (MBT), 2-mercaptobenzothiazole sodium salt (NaMBT), and 2-mercaptobenzothiazole zinc salt (ZnMBT). These may be used alone or two or more thereof may be used in combination. Among these, dibenzothiazyl disulfide (MBTS) and 2-mercaptobenzothiazole (MBT) are particularly preferably used because they have excellent crosslinking reactivity.

Examples of sulfenamide-based vulcanization accelerators include N-oxydiethylene-2-benzothiazolylsulfenamide (NOBS), N-cyclohexyl-2-benzothiazolylsulfenamide (CBS), N-t-butyl-2-benzothiazoylsulfenamide (BBS), and N,N′-dicyclohexyl-2-benzothiazoylsulfenamide.

Examples of thiuram-based vulcanization accelerators include tetramethylthiuram disulfide (TMTD), tetramethylthiuram disulfide (TETD), tetrabutylthiuram disulfide (TBTD), tetrakis(2-ethylhexyl)thiuram disulfide (TOT), and tetrabenzylthiuram disulfide (TBzTD).

Examples of vulcanization aids include zinc oxide (ZnO), stearic acid, and magnesium oxide. These may be used alone or two or more thereof may be used in combination.

In addition, when the vulcanization aid is used, the amount thereof added with respect to 100 parts by mass of the diene-based rubber (A) is preferably in a range of 1 to 25 parts by mass and particularly preferably in a range of 3 to 10 parts by mass.

Examples of antioxidants include carbamate-based antioxidants, phenylenediamine-based antioxidants, phenol-based antioxidants, diphenylamine-based antioxidants, quinoline-based antioxidants, imidazole-based antioxidants, and waxes. These may be used alone or two or more thereof may be used in combination.

In addition, when the antioxidant is used, the amount thereof added with respect to 100 parts by mass of the diene-based rubber (A) is preferably in a range of 1 to 10 parts by mass, and particularly preferably in a range of 2 to 5 parts by mass.

Examples of process oils include a naphthenic oil, a paraffin oil, and an aroma oil. These may be used alone or two or more thereof may be used in combination.

In addition, when the process oil is used, the amount thereof added with respect to 100 parts by mass of the diene-based rubber (A) is preferably in a range of 1 to 50 parts by mass and particularly preferably in a range of 3 to 30 parts by mass.

### [Method of Preparing Vibration-Damping Rubber Composition]

The present vibration-damping rubber composition can be prepared, for example, as follows. That is, using a diene-based rubber (A), a specific silica (B), and a specific silane coupling agent (C), and additionally, as necessary, using other materials listed above, these can be prepared by kneading them using a kneading machine such as a kneader, a Bunbury mixer, an open roll, or a twin screw stirrer.

Particularly, the kneading is preferably performed by kneading a vulcanizing agent and materials other than the vulcanization accelerator using a Bunbury mixer, at 100 to 170° C. for 3 to 10 minutes (preferably kneading at 150 to 160° C. for 3 to 5 minutes) and then adding the vulcanizing agent and the vulcanization accelerator, and kneading them using an open roll at 30 to 80° C. for 3 to 10 minutes (preferably kneading at 30 to 60° C. for 3 to 5 minutes).

The present vibration-damping rubber composition obtained in this manner can achieve excellent durability and a low dynamic-to-static modulus ratio, and can exhibit excellent scorch resistance even in a wet-heat environment.

Here, the present vibration-damping rubber composition is vulcanized at a high temperature (150 to 170° C.) for 5 to 30 minutes to obtain a vibration-damping rubber member (vulcanized component).

The vibration-damping rubber member composed of the vulcanized component of the present vibration-damping rubber composition is preferably used as a structural member of engine mounts, stabilizer bushes, suspension bushes, motor mounts, and subframe mounts used in vehicles such as automobiles.

In addition, in addition to the above applications, the member can also be used for vibration control dampers for computer hard disks, vibration control dampers for general home appliances such as washing machines, damping (vibration control) devices such as construction damping walls and damping (vibration control) dampers in the field of construction and housing, and base isolation devices.

### EXAMPLES

Next, examples will be described together with comparative examples. However, the present disclosure is not limited to these examples.

First, before examples and comparative examples were performed, silica prototypes (silicas (I) to (VI)) whose silanol group density, BET specific surface area, and average particle diameter were adjusted to values shown in the following Table 1 were prepared.

In addition, the following silicas (VII) and (VIII) were prepared as commercially available silicas.
silica (VII): ULTRASIL VN-3, commercially available from DEGUSSA
silica (VIII): Nipsil E75, commercially available from Tosoh Silica Corporation

Here, the measured values for the silicas (I) to (VIII) shown in the following Table 1 were values measured according to the above method.

TABLE 1

| | Silica | | | | | | | |
|---|---|---|---|---|---|---|---|---|
| | I | II | III | IV | V | VI | VII | VIII |
| Silanol group | 4.0 | 7.5 | 10.1 | 14.4 | 10.1 | 10.1 | 5.5 | 3.2 |
| density | | | | | | | | |
| (groups/nm²) | | | | | | | | |
| BET specific | 60 | 29 | 18 | 15 | 18 | 18 | 210 | 45 |
| surface area | | | | | | | | |
| (m²/g) | | | | | | | | |
| Average | 3.7 | 5.0 | 9.2 | 5.0 | 3.6 | 2.0 | 15.0 | 2.3 |
| particle | | | | | | | | |
| diameter (μm) | | | | | | | | |

In addition, the following commercially available silane coupling agents (i) to (iii) were prepared as silane coupling agents.

[Silane Coupling Agent (i)]

A silane coupling agent having a sulfide group and a mercapto group in the molecule (NXT, commercially available from Momentive Performance Materials)

[Silane Coupling Agent (ii)]

A silane coupling agent having a mercapto group but having no sulfide group in the molecule (A-189, commercially available from Momentive Performance Materials)

[Silane Coupling Agent (iii)]

A silane coupling agent having a mercapto group but having no sulfide group in the molecule (VPSi363, commercially available from Evonik Degussa Corporation)

### Examples 1 to 8 and Comparative Examples 1 to 4

100 parts by mass of a natural rubber, a silica, a silane coupling agent, carbon black (Shoblack N330, commercially available from Carbot Japan, BET specific surface area 75 m²/g (value measured according to the above method)), 5 parts by mass of zinc oxide (zinc oxide (type II), commercially available from Sakai Chemical Industry Co., Ltd.), 1 part by mass of stearic acid (Stearic Acid Cherry (Beads), commercially available from NOF Corporation), 2 parts by mass of an antioxidant (Antigen 6C, commercially available from Sumitomo Chemical Co., Ltd.), 2 parts by mass of a wax (OZOACE0062, commercially available from Nippon Seiro Co., Ltd.), and 5 parts by mass of a process oil (Sunthene 410, commercially available from Japan Sun Oil Co., Ltd.) were kneaded using a Bunbury mixer at 150° C. for 5 minutes. 2 parts by mass of CBS (ACCEL CZ, commercially available from Kawaguchi Chemical Industry Co., Ltd.) as a vulcanization accelerator, 1 part by mass of TMTD (ACCEL TMT, commercially available from Kawaguchi Chemical Industry Co., Ltd.), and 1 part by mass of a vulcanizing agent (sulfur, commercially available from Karuizawa Refinery) were added to the kneaded product obtained in this manner, and these were kneaded using an open roll at 60° C. for 5 minutes to prepare a vibration-damping rubber composition.

Here, in the vibration-damping rubber compositions of the examples and comparative examples, the contents of the silica, the silane coupling agent, and the carbon black (content with respect to 100 parts by mass of the natural rubber), and the types of silica and silane coupling agent used are also shown in Tables 2 and 3 below.

Using the vibration-damping rubber compositions of the examples and comparative examples obtained in this manner, based on the following criteria, properties were evaluated. The results are also shown in Table 2 below.

### <Initial Physical Properties>

Each vibration-damping rubber composition was press-molded and vulcanized under conditions of 150° C.×20 minutes to produce a rubber sheet with a thickness of 2 mm. A JIS No. 5 dumbbell was punched out from this rubber sheet, and using this dumbbell, the tensile strength at break (TS), the elongation at break (EB) and the hardness (JIS A) were measured according to JIS K 6251.

Here, those having a TS value of 18 to 28 MPa, an EB value of 450 to 700%, and a hardness (JIS A) of 40 to 50 were determined as good.

<Dynamic properties>

### [Static Spring Constant: Ks]

Using each vibration-damping rubber composition, a disk-shaped metal fitting (with a diameter of 60 mm and a thickness of 6 mm) was pressed, vulcanized, and adhered onto upper and lower surfaces of a rubber piece (with a diameter of 50 mm and a height of 25 mm) under vulcanization conditions of 170° C.×30 minutes to produce a test piece. Next, the test piece was compressed by 7 mm in the cylinder axis direction, the load at 1.5 mm and 3.5 mm deflection was read from the load deflection curve of the second pass, and the static spring constant (Ks) was calculated.

### [Dynamic Spring Constant: Kd100]

The test piece was compressed by 2.5 mm in the cylinder axis direction, a constant displacement harmonic compression vibration with an amplitude of 0.05 mm was applied from below at a frequency of 100 Hz around the position of this 2.5 mm compression, a dynamic load was detected by the upper load cell, and the dynamic spring constant (Kd100) was calculated and measured according to JIS K 6394.

### [Dynamic-to-Static Modulus Ratio: Kd100/Ks]

The dynamic-to-static modulus ratio was determined as the value of dynamic spring constant (Kd100)/static spring constant (Ks).

Here, those having a value of 1.30 or less were determined as good.

### <Scorch Resistance>

For each vibration-damping rubber composition, the scorch time (ST) at a test temperature (121° C.) was measured using a Mooney viscometer (commercially available from Toyo Seiki Co., Ltd.).

Here, those having a value of 16 minutes or longer were determined as good.

### <Durability>

Each vibration-damping rubber composition was press-molded (vulcanized) under conditions of 150° C.×30 minutes to produce a rubber sheet with a thickness of 2 mm. Then, a JIS No. 3 dumbbell was punched out from this rubber sheet, and using this dumbbell, the expansion and contraction fatigue test was performed according to JIS K 6260.

Here, the number of expansions and contractions at breakage was measured, and the durability was evaluated based on the following criteria.
O (very good): the number of expansions and contractions was 300,000 or more.
× (poor): the number of expansions and contractions was less than 300,000.

TABLE 2

| | | Example | | | | | | | | Comparative Example | | | |
|---|---|---|---|---|---|---|---|---|---|---|---|---|---|
| | | 1 | 2 | 3 | 4 | 5 | 6 | 7 | 8 | 1 | 2 | 3 | 4 |
| Silica | I | 20 | — | — | — | — | — | — | 20 | — | — | — | — |
| (parts by | II | — | 20 | — | — | — | — | — | — | — | — | — | — |
| mass) | III | — | — | 20 | — | — | — | — | — | — | — | — | — |
| | IV | — | — | — | 20 | — | — | — | — | — | — | — | — |
| | V | — | — | — | — | 20 | — | 20 | — | 20 | 20 | — | — |
| | VI | — | — | — | — | — | 20 | — | — | — | — | — | — |
| | VII | — | — | — | — | — | — | — | — | — | — | 20 | — |
| | VIII | — | — | — | — | — | — | — | — | — | — | — | 20 |
| Silane | i | 2 | 2 | 2 | 2 | 2 | 2 | 1 | 2 | — | — | 2 | 2 |
| coupling | ii | — | — | — | — | — | — | 1 | — | 2 | — | — | — |
| agent | iii | — | — | — | — | — | — | — | — | — | 2 | — | — |
| (parts by | | | | | | | | | | | | | |
| mass) | | | | | | | | | | | | | |
| Carbon black (parts | | — | — | — | — | — | — | — | 3 | — | — | — | — |
| by mass) | | | | | | | | | | | | | |
| Initial | TS (MPa) | 26.2 | 24.0 | 20.5 | 20.0 | 21.6 | 22.0 | 21.6 | 26.2 | 21.6 | 21.6 | 28.0 | 21.8 |
| physical | EB (%) | 550 | 530 | 560 | 550 | 560 | 560 | 560 | 550 | 560 | 560 | 640 | 580 |
| properties | Hardness | 45 | 44 | 42 | 42 | 42 | 42 | 42 | 45 | 42 | 42 | 48 | 44 |
| | (JIS-A) | | | | | | | | | | | | |
| Dynamic | Ks (N/mm) | 413 | 421 | 408 | 411 | 413 | 408 | 420 | 420 | 421 | 416 | 410 | 400 |
| properties | Kd100 | 538 | 541 | 508 | 516 | 520 | 510 | 504 | 542 | 505 | 487 | 615 | 540 |
| | (N/mm) | | | | | | | | | | | | |
| | Kd100/Ks | 1.30 | 1.29 | 1.25 | 1.26 | 1.26 | 1.25 | 1.20 | 1.29 | 1.20 | 1.17 | 1.5 | 1.35 |

| | | | | | | | | | | | | |
|---|---|---|---|---|---|---|---|---|---|---|---|---|
| Scorch resistance | 20 | 20 | 20 | 20 | 20 | 20 | 16 | 20 | 10 | 13 | 20 | 20 |
| (min) | | | | | | | | | | | | |
| Durability | ◯ | ◯ | ◯ | ◯ | ◯ | ◯ | ◯ | ◯ | ◯ | ◯ | ◯ | ◯ |

Based on the results of Table 2, all rubber compositions of the examples using silicas (I) to (VI) having a silanol group density of 4 groups/nm² or greater, a BET specific surface area of 13 to 60 m²/g, and an average particle diameter of 3 to 10 μm, and a silane coupling agent (i) having a sulfide group and a mercapto group in the molecule had excellent initial physical properties, dynamic properties, scorch resistance, and durability.

On the other hand, in the results, the rubber compositions of Comparative Examples 1 and 2 in which only silane coupling agents (ii) and (iii) having a mercapto group but having no sulfide group in the molecule were used as the silane coupling agent had poorer scorch resistance than the rubber compositions of the examples. In addition, in the results, the rubber compositions of Comparative Examples 3 and 4 using silicas (VII) and (VIII) that did not meet requirements specified in the present disclosure did not have a desired low reduction in dynamic-to-static modulus ratio compared to the rubber compositions of the examples.

While specific embodiments of the present disclosure have been described in the above examples, the above examples are only examples, and should not be construed as limiting. Various modifications apparent to those skilled in the art are intended to be within the scope of the present disclosure.

### INDUSTRIAL APPLICABILITY

The vibration-damping rubber composition of the present disclosure is preferably used as a material for structural members (vibration-damping rubber members) of engine mounts, stabilizer bushes, suspension bushes, motor mounts, and subframe mounts used in vehicles such as automobiles, and also can be used as a material for vibration control dampers for computer hard disks, vibration control dampers for general home appliances such as washing machines, damping (vibration control) devices such as construction damping walls and damping (vibration control) dampers in the field of construction and housing, and members (vibration-damping rubber members) constituting base isolation devices.

1. A vibration-damping rubber composition, comprising a diene-based rubber composition containing following (A) to (C):
(A) a diene-based rubber;
(B) a silica having a silanol group density of 4 groups/nm² or greater, a BET specific surface area of 13 to 60 m²/g, and an average particle diameter of 3 to 10 μm; and
(C) a silane coupling agent having a sulfide group and a mercapto group in a molecule.

2. The vibration-damping rubber composition according to claim 1,
wherein the content of the (C) with respect to 100 parts by mass of the (A) is 0.5 to 10 parts by mass.

3. The vibration-damping rubber composition according to claim 1,
wherein a content of the above (B) with respect to 100 parts by mass of the (A) is 10 to 100 parts by mass.

4. The vibration-damping rubber composition according to claim 1, further comprising following (D):
(D) carbon black.

5. The vibration-damping rubber composition according to claim 4,
wherein a content of the (D) with respect to 100 parts by mass of the (A) is 0.1 to 5 parts by mass.

6. The vibration-damping rubber composition according to claim 4,
wherein the BET specific surface area of the (D) is 10 to 150 m²/g.

7. A vibration-damping rubber member, comprising a vulcanized component of the vibration-damping rubber composition according to claim 1.
